(19) United States
(12) Patent Application Publication
(10) Pub. No.: US 2007/0193312 A1
(43) Pub. Date: Aug. 23, 2007

(54) Light weight hinged handcuff

(76) Inventor: Kevin L. Parsons, Appleton, WI (US)

Correspondence Address: Welsh & Katz, Ltd.;Jon P. Christensen, 22nd Floor, 120 South Riverside Plaza, Chicago, IL, 60606, US

(21) Appl. No.: 11/361,472

(22) Filed: Feb. 23, 2006

(51) Int. Cl. E05B 75/00

(52) U.S. Cl. 70/16

(57) ABSTRACT

A handcuff assembly is provided that includes a pair of handcuffs. The handcuff assembly including a frame including a plurality of support loops, a flat connector link connecting the pair of handcuffs, the connector link extending into a notch between the plurality of support loops of the frame, a retaining pin that extends through the plurality of support loops of the frame and through an aperture in an end of the connector link to connect the connector link to the frame and an overmold that covers opposing ends of the support loops and that prevents removal of the retainer pin from the frame.

### BACKGROUND OF THE INVENTION

1. Field of the Invention

The present invention relates to an improved set of handcuffs having a number of features, which facilitate their use. These features include, for example, a connecting hinge that facilitate placing the handcuffs over an officer's belt, a slightly larger bow for engaging a wrist of a person to be restrained where the envelope of the bow is defined by a conic path with an increasing arc, a rounded inner surface of the bow and cooperating arcuate cheek arms, cheek arms formed from a metal plate and having reinforcing ribs, a molded polymer covering surrounding the cheek arms and providing a rounded surface on the inner edge of the cheek arms which engage a wrist of a prisoner, interlocking tabs on the folded cheek arm forming plates, the folded cheek-arm forming plates which are covered by the polymer molding providing a non-riveted base frame and cheek arms, a flat on an outer surface of the bow for lining up a point of contact with a wrist, a removable lockset assembly for locking a pawl relative to ratchet teeth on the bow and including a slideable lock bar, key receiving structure on each side of the lockset assembly for receiving a key and enabling the key to be turned in one direction only for first unlocking a double lock, which prevents movement of the bow in either direction and for secondly, completely unlocking the handcuff by moving the pawl away from the bow and against a spring mechanism and a deflectable detent on a lockset housing for releasably locking the lockset assembly within the base frame of the molded cheek plate assembly.

2. Description of the Related Art

Heretofore, a large number of handcuffs have been proposed. Several prior art U.S. Patents disclosing previously proposed handcuffs and features thereof are set forth in the analogous and non-analogous U.S. Patents listed below:

| U.S. PAT. NO. | PATENTEE |
|---|---|
| 4,314,466 | Harris |
| 4,574,600 | Moffett |
| 5,660,064 | Ecker et al. |
| 6,574,998 | Kwon |
| 6,672,116 | Hilliard |

Prior art handcuffs are typically known to be heavy and include a cheek plate assembly made of metal plates which are cut to a desired shape and riveted together such that rivet heads protrude from the sides of the cheek assembly.

In view of the rivet heads protruding form the cheek plate assembly, it is hard to align the cuffs and to fold the cuffs flat.

Also, in many designs of prior art handcuffs, a set of connecting links are provided for connecting one handcuff to another handcuff. The connecting links are fixed in a cheek plate assembly prior to riveting such that if one handcuff is defective after riveting, the whole set, i.e., both handcuffs, have to be discarded.

Further, in prior art handcuffs the lock mechanism is subject to damage such as the breaking off of key posts or pins, chipped teeth, fatigued springs, sticking of double-lock bars, rusting and clogging with debris which require complete replacement of the handcuffs.

Often it is difficult to unlock the handcuffs on the street. Further, difficulty is often incurred in removing the cuffs, particularly, from large subjects.

Prior art handcuffs typically only have one keyway in the cheek plate assembly such that a user of the handcuffs has to be trained to always apply handcuffs with the keyway facing away from the subject in order to insert the key.

Also, the handcuff key is rotatable in both directions. Rotation of the key in one direction unlocks a double lock while rotation in the other direction releases the handcuff from the subject. This leads to confusion as to which way to turn the key for a desired operation.

Often times, the cheek plates and/or the bow of the handcuff have edges along the inside of the curved surface of the bow or cheek plates which can cause trauma or injury to a wrist.

Also, the curved envelope of the bow and the curved envelope of the cheek plates in conventional handcuffs often do not properly fit many wrists and sometimes are not large enough or small enough.

As will be described in greater detail hereinafter, the handcuffs of the present invention have high strength and are relatively light weight with an arcuate conic-generated envelope design for the bow and for the cheek plates which provide handcuffs for accommodating a large wrist while at the same time being able to secure small wrists of juveniles and women.

The bow is preferably made of sintered metal powder with rounded inner edges and an outer flat contact surface. It is preferably polymer infused to prevent corrosion and absorption of body fluids, e.g., sweat.

Strength of the bow and cheek plates is maximized by the selection of an optimal combination of materials and heat treatment of the materials as well as design of frame geometry and provision of reinforcing ribs. Also, the use of a die stamped metal plate facilitates forming of a base frame and cheek plate arms of a unitized cheek plate assembly.

Furthermore, the use of a polymer overmold over the cheek plate frame produces a pair of a handcuff with rounded edges, beveled lock slots and beveled keyways. Additionally the polymer can be color coded to indicate the source of the handcuffs.

Finally, punching of track guide forming detents facilitates the forming of bowed or arcuate track guides for being received in track grooves in a toothed track portion.

Also, a unitized, replaceable lockset assembly is provided having a number of features including: a keyway on each side of a lockset assembly housing, a lock slot on each side, a slidable lock bar inside the housing with a locksetting slot aligned with the lock slots, color coding of the lock bar to facilitate locating same for inserting an actuating pin in the locksetting slot to move the lock bar between a single lock position and a double lock position, double locking of the teeth on the bow engaging teeth on a pawl, structure on the pawl and structure on the lock bar enabling a hand cuff key to be rotated in one direction only when inserted in either keyway and rotation in the one direction to move the lockset mechanism from a double lock position, to a single lock position and then to a completely unlock position.

### BRIEF SUMMARY OF THE INVENTION

According to one of the teachings of the present invention, a handcuff assembly is provided that includes a pair of handcuffs. The handcuff assembly including a frame including a plurality of support loops, a flat connector link connecting the pair of handcuffs, the connector link extending into a notch between the plurality of support loops of the frame, a retaining pin that extends through the plurality of support loops of the frame and through an aperture in an end of the connector link to connect the connector link to the frame and an overmold that covers opposing ends of the support loops and that prevents removal of the retainer pin from the frame.

### BRIEF DESCRIPTION OF THE SEVERAL VIEWS OF THE DRAWINGS

FIG. 1 is a plan view of a pair of handcuffs constructed according to the teachings of the present invention.

FIG. 2 is a plan view of a punched plate, which is folded over to create a pair of cheek plates.

FIG. 3 is a side, top and end view of a connecting link insert shown in FIG. 1.

FIG. 4 is a perspective view of the punched plate shown in FIG. 2 folded over and molded to form a unitized steel frame including the base frame portion and the cheek plates with the link set mounted in the base frame portion.

FIG. 5 is an end view of the unitized steel frame and shows the frame interlock in the base frame portion.

FIG. 6 is a perspective exploded view of one handcuff showing an open position of the bow relative to the encapsulated unitized steel frame and shows an exploded view of a rivet for connecting the bow to the pair of cheek plates and an exploded view of two (2) link sets mounted to the base frame;

FIG. 7 is a is a sectional view of the completed rivet after swaging;

FIG. 8 is an exploded perspective view of the double key lock insert assembly.

FIG. 9 is a plan view of one handcuff showing the bow in an open position relative to the encapsulated cheek plates and base frame portion and shows the double key lock insert assembly about to be inserted into the base frame portion;

FIG. 10 is a perspective view of the encapsulated cheek plates and base frame portion with the double key lock insert assembly partially inserted into the base frame portion.

FIG. 11 is a perspective view similar to FIG. 10 and shows the double key lock insert assembly almost fully inserted into the base frame portion.

FIG. 12 is a perspective view of one handcuff in the closed position and shows two (2) keys positioned on either side of the base frame portion for insertion into the base frame portion for unlocking the handcuff.

FIG. 13 is a perspective view of the tooth track portion of the bow interacting with a double lock bar pawl in the double key lock insert assembly and shows the end portions of two (2) keys inserted from either side of the handcuff positioned to interact with arms of the double lock bar pawl;

FIG. 14 is a plan view of tooth track portion of the bow engaged with the double lock bar pawl and shows a double lock bar in a single locked position where the tooth track portion can be moved or ratcheted forward.

FIG. 15 is a plan view similar to FIG. 14 and shows the double lock bar moved to the double locked position where the tooth track portion of the bow cannot be retracted or ratcheted forward.

FIG. 16 is a fragmentary perspective view of the double lockset assembly showing the locking bar in the double locked position with a key inserted from the other side of the handcuff.

FIG. 17 is a view similar to the view shown in FIG. 16 and shows the key rotated counterclockwise to move the tooth against a shoulder of the double lock bar to move the double lock bar relative to the double lock bar pawl to a pawl ratchet position.

FIG. 18 is a view similar to the view shown in FIG. 17 and shows the tooth of the key rotated further counterclockwise to engage a shoulder on one (1) arm of the double lock bar pawl for moving the double lock bar pawl completely out of engagement with the tooth track portion of the bow;

FIG. 19 is a plan view of the bow mounted to the cheek plates prior to encapsulation of the unitized steel frame and shows a detent formed in one (1) side of the base frame portion received in a track groove in the tooth track portion.

FIG. 20 is a sectional view through the handcuff shown in FIG. 22, taken along line 23-23 of FIG. 2 and shows detents in each plate of the base frame portion received in track grooves in each side of the tooth track portion of the bow;

FIG. 23 is a perspective view of the bow mounted to the cheek plates prior to encapsulation of the unitized steel frame and shows the tip of the bow and tooth track portion prior to engaging with the detents in the plates of the base frame portion;

FIG. 24 is an enlarged view of the portions broken away of the bow mounted to the cheek plates prior to encapsulation of the unitized steel frame and shows the tip of the bow and tooth track portion prior to engaging with the detents in the plates of the base frame portion.

### DETAILED DESCRIPTION OF THE INVENTION

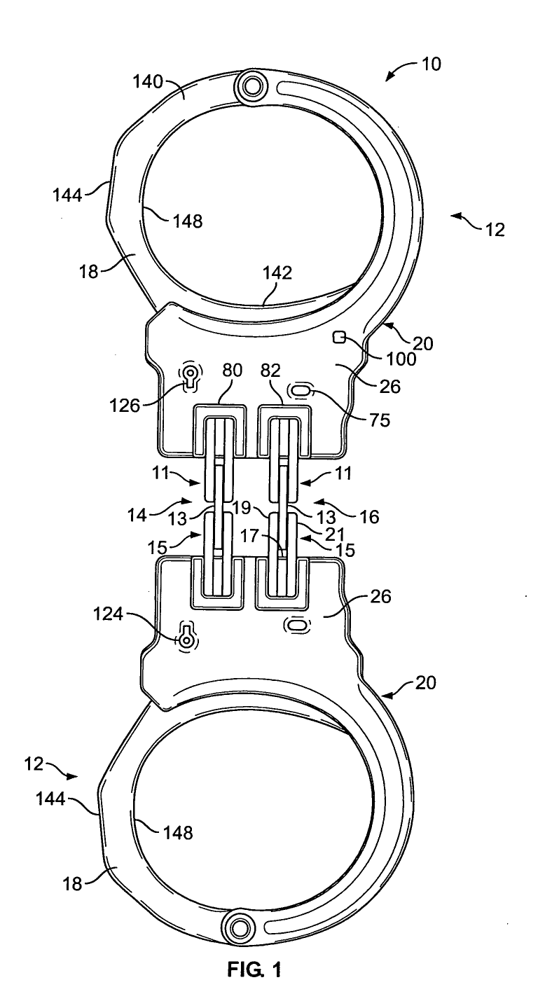

Referring now to the drawings in greater detail, there is illustrated in FIG. 1 a set of handcuffs 10 including two cuffs 12 linked together by two hinge sets 14 and 16. Each cuff 12 comprises a bow 18, pivotally connected to a molded cheek plate assembly 20.

The bow 18 and cheek plate assembly 20 together lie within (and define) a single predominant plane 59 of each cuff. The hinge sets 14, 16 allow movement (rotation) only about an axis that is parallel to the predominant plane of the cuffs. Stated another way, each hinge set 14, 16 is only rotates in a plane that is perpendicular to the predominant plane of the cuffs.

The hinge sets 14, 16 may be constructed of a number of flat metal plates (links) that are all parallel to one another. In each case, the hinge set 14, 16 includes three elements 11, 13, 15. A center element 13 may be simply a flat plate with apertures on opposing ends. The elements on opposing ends 11, 15 may include a pair of flat plates 19, 21 with a spacer 17. The flat plates 13, 19, 21 may be substantially identical. Rivets may be used as connection elements between the plates 13, 19, 21 that define the hinge sets 14, 16.

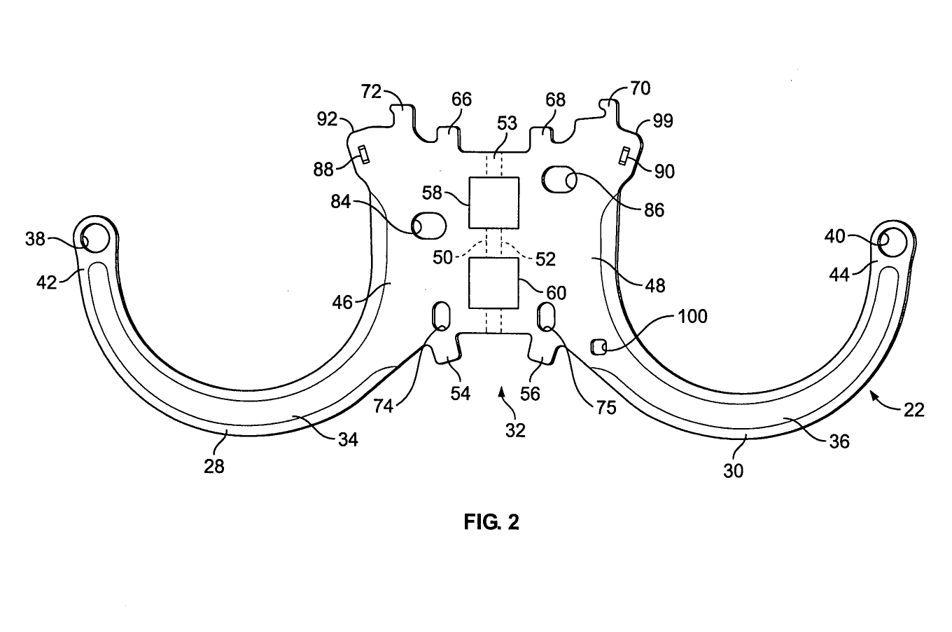

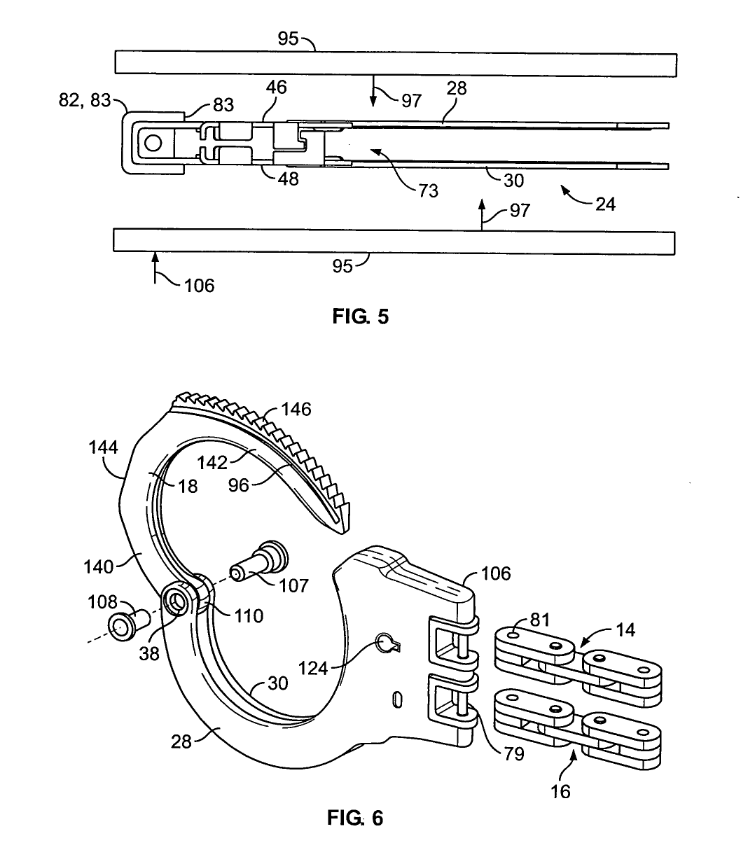

FIG. 2 illustrates a die stamped, stainless steel, metal plate 22 which is folded, bent or formed into a cheek plate frame assembly 24 including a base frame 26 and parallel spaced cheek arms 28 and 30 as shown in FIGS. 4 and 5.

In the figures, it will be understood that, for the sake of clarity and illustration, in some places the cheek plate frame assembly 24 is illustrated instead of the overmolded cheek plate assembly 20, which is the cheek plate frame assembly having a plastic overmold thereon.

The die stamped plate 22 includes a central base frame forming section 32 and first and second cheek arms or cheek arm plates 28 and 30 which form the cheek plate frame assembly 24 shown in FIGS. 4 and 5. A reinforcing rib 34 or 36 is stamped in each cheek arm plate 28, 30 and a hole 38 or 40 is punched in an outer end 42 or 44 of each cheek arm plate 28, 30 for facilitating pivotal mounting of the bow 18 to and between the cheek arms 28 and 30.

The central base forming section 32 of the die stamped metal plate 22 is specially configured as shown so that when side plates 46 and 48 are folded about phantom lines 50 and 52 to form bottom plate 53, end tabs 54 and 56 are folded inwardly, front tabs 66 and 68 are folded inwardly and hook formations 70 and 72 are folded inwardly, as shown in FIG's. 4 and 5, the unitary base frame 26 is formed with a strong frame interlock 73 formed by the interlocking hook formations 70 and 72.

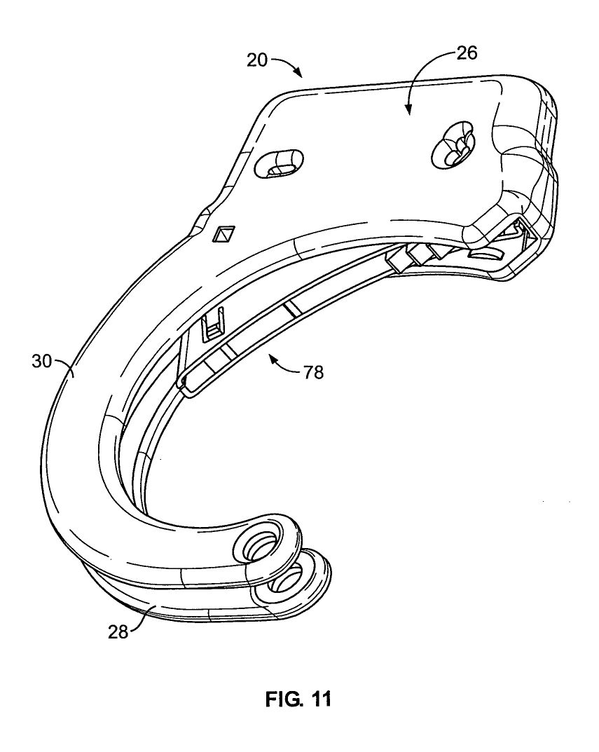

The base frame forming portion 32 further includes two oval-shaped holes 74 and 75 punched therein which, when portions of the base frame forming portion 32 are folded will form aligned, opposed double-lock slots 74 and 75 for mating with a locksetting slot 76 in a double lock bar 77 in a lockset assembly 78 described in greater detail hereinafter in connection with the description of FIGS. 11 and 16-21.

Further, a set of square center apertures 58, 60 may be stamped into the metal plate 22. The folding of the side plates 46, 48 along fold lines 50, 52 creates a number of support loops 61, 63, 65 that function to support a connection with the hinge sets 14, 16. After folding, the apertures 58, 60 form a pair of slots or notches 62, 64 (FIG. 4) that receive opposing ends of the hinge sets 14, 16. The folded junction of the bottom plate 53 and side plates 46, 48A (i.e., the support loops 61, 63, 65) define three sides of an aperture 93 for a retaining (mounting) pin 79 (FIG. 6) that secures the hinge sets 14, 16 to the base frame 26.

Folding the metal plate 22 along the fold lines 50, 52 creates a cheek plate assembly 20 that is lightweight, yet extremely strong. The folded metal plate 22 forms a continuous, unitary metal plate connection from a pivot point of the bow within first cheek plate 28 on a first end of the plate 22 around the mounting pin 79 (via the support loops 61, 63, 65) and back to the pivot point of the bow within a second cheek plate 30 on a second end of the plate 22. The continuous nature of the metal plate connection allows the metal plate 22 to be much thinner and lighter and yet provide far greater strength than conventional riveted handcuff base frames.

A partial keyway defined by openings 84 and 86 are also formed in the die stamped metal plate 22, namely in the side plates 46 and 48 on either side of the bottom plate 53, such that a key can be inserted through either one of these keyway forming openings 84, 86 from either side of the base frame 26.

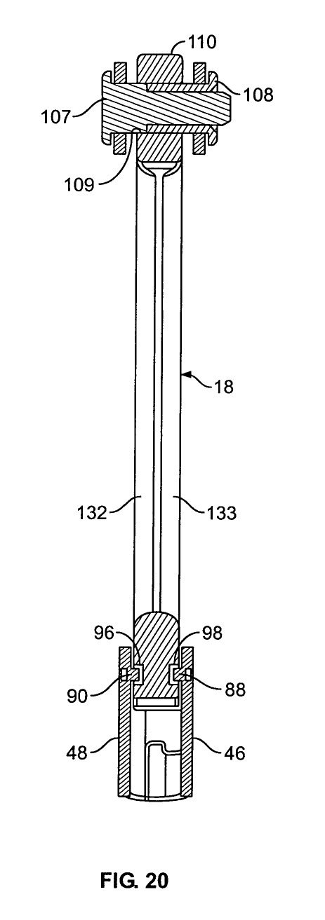

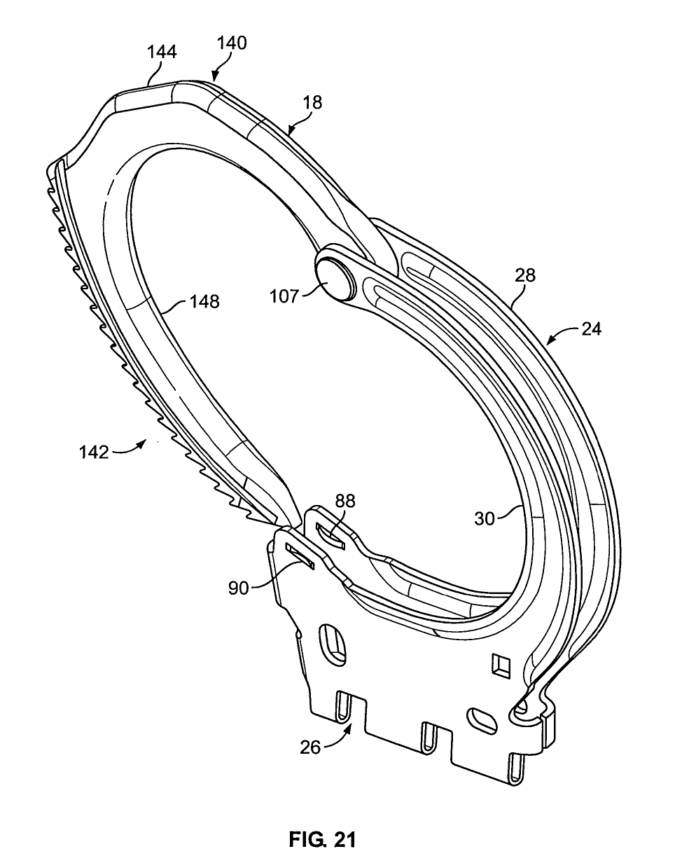

Also, two detents or track guides 88 and 90 are punched into the side plates 46 and 48 adjacent a corner 92 or 94 of the side plate 46 or 48 for being received in a track groove 96 or 98 (FIG. 20) in the bow 18.

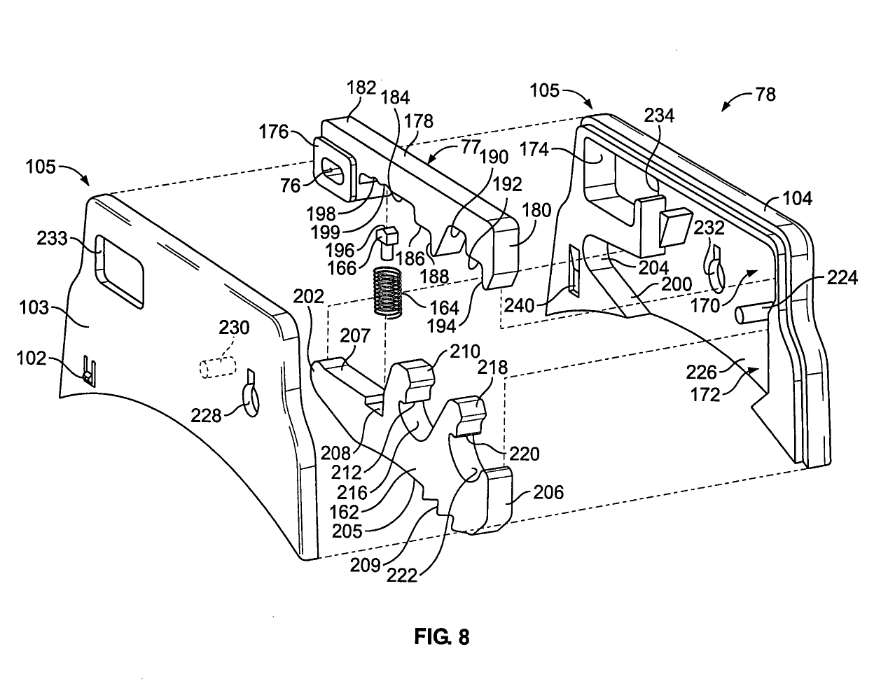

Finally, a latch hole or notch 100 is provided in one of the side plates 46, 48, in the illustrated embodiment in side plate 48, for receiving a flexible detent 102 in/on a cover 103 for a housing shell 104 for a housing 105 of the lockset assembly 78 (FIG. 8) for latching the lockset assembly 78 in the base frame 26 while permitting removal of the lockset assembly 78 from the base frame 26.

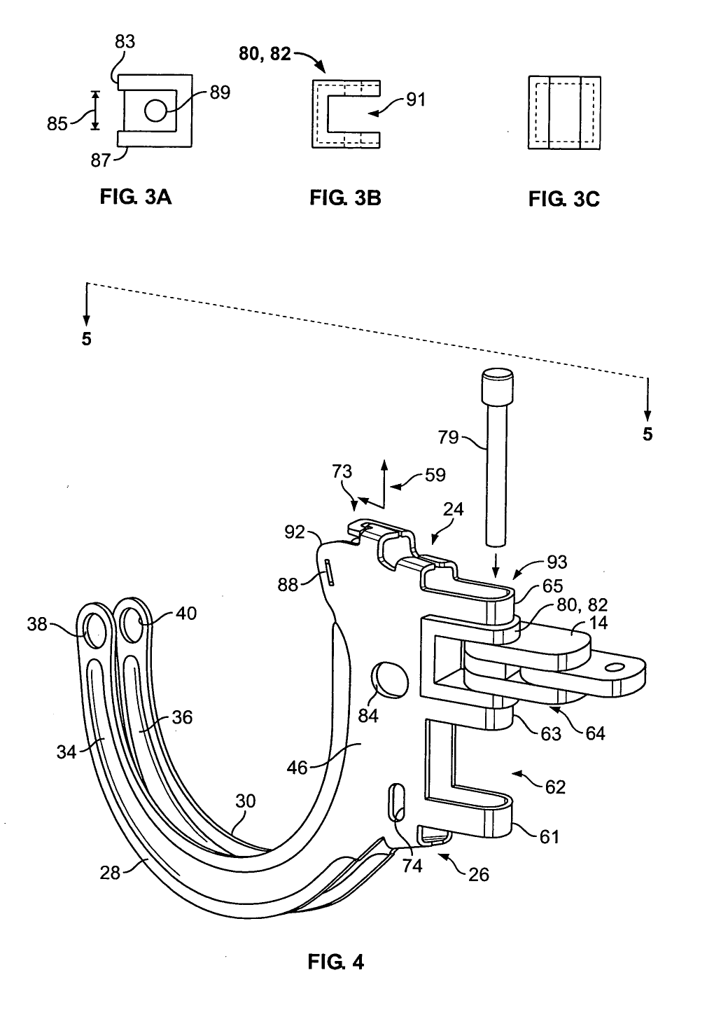

In order to assemble the hinge sets 14, 16, a hinge insert 80, 82 (FIG. 3) may first be inserted into each of the slots 62, 64. As shown in FIG. 3, the hinge inserts 80, 82 are U-shaped structures with a dimension 85 intended to be received within the slots 62, 64. A raised area or flange 83, 87 of the hinge insert 80, 82 extends above and outwards over an outer surface of the base frame 26. The flange 83, 87 essentially serves three purposes. One purpose of the flange 83, 87 is to prevent the inserts 80, 82 from extending too far into the slots 62, 64. The flanges 83, 87 stop the inserts 80, 82 from entering the slots 62, 64 any further that what is necessary for the hole 89 to receive the retaining pin 79 through the inside of the support loops 61, 63, 65.

It should be noted that the retaining pin 79 is shown in FIG. 4 as having an enlarged end or head. The enlarged head may be used as a stop to prevent the retaining pin 79 from being inserted too far into the aperture 93. In this case, the retaining pin 79 enlarged head would be inserted into the aperture 93 until the head strikes the smaller hole 89 within the insert 80, 82.

In order to better distribute forces within the support loops 61, 63, 65, one or more metallic tubular spacers (not shown) may be inserted onto the retaining pin 79 inside the remaining support loops 63, 65 where the outer diameter of the tubular spacers are equal to the diameter of the head on the retaining pin 79 and the inner diameter of the spacers is substantially equal to a shaft of the retaining pin 79.

The raised outer surface of the flanges 83, 87 also serves a second purpose. The second purpose is to contact and form a seal between the base frame 26 and inserts 80, 82 and between the inserts 80, 82 and an inner surface of a mold. The seal between the base frame 26 and inserts 80, 82 prevents the overmolding material from entering an inside chamber of the base frame 26 that will later be occupied by the lockset assembly 78. The seal between the flanges 83, 87 prevents overmolding material from entering the area of the hinge connection.

An inside area 91 of the inserts 80, 82 is dimensioned to receive one end of the hinge set 14, 16. Once the hinge inserts 80, 82 have been inserted into the slots 62, 62, a first end of the hinge set 14 may be inserted into the hinge insert 80, 82 and joined to the base 26 by insertion of the retaining pin 79 as shown in FIG. 4. The retaining pin 79 may be inserted through the aperture 93 in the folded portion, through the holes 89 in the hinge inserts 80, 82 and holes 81 in the hinge links 14, 16.

Once the hinge connection has been assembled, a set of molds 95 may be closed 97 around the frame assembly 24 and an overmolding material may be injected into the mold 95. It should be specifically noted from the partially exploded view of FIG. 6 that the overmold 106 covers opposing ends of the aperture 93 in the folded portion thereby preventing removal of the retaining pin 79 and disassembly and release of the hinge links 14, 16. It should also be noted that since the flanges 83, 87 form a seal between the mold 95 and base frame, the thickness of the overmold is the same as the thickness of the flanges 83, 87, thereby provide a smooth overall surface finish over the base frame.

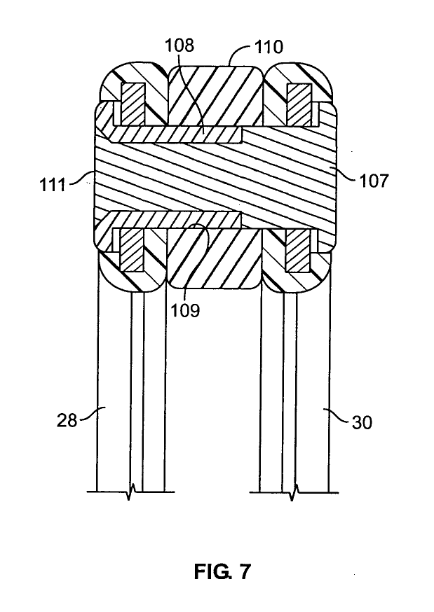

In FIG. 6 is illustrated a perspective view of an open cuff 12 showing a stainless steel pivot pin 107 and a stainless steel pivot bushing 108 positioned for insertion through holes 38 and 40 in the cheek arms 28 and 30 and a hole 109 (FIG. 7) in a base end 110 of the bow 18. The pin 107 is swaged, staked or riveted in place as shown at 111 in FIG. 7.

The cheek arms 28 and 30 are positioned to be parallel spaced from each other as shown. Then, the side plates 46 and 48 and bottom plate 53, as well as the cheek arms 28 and 30 are covered with the plastic overmold 106 to provide the cheek plate assembly 20 with rounded edges and corners. Also the double lock slots 74 and 75 are beveled as a result of the plastic overmold as are keyways 124 and 126 formed in openings 84 and 86 in side plates 46 and 48.

It should be noted, that the plastic overmold 106 enables the cheek plate assembly 20 to have curved, rounded, or beveled edges which will minimize injury to a wrist from the cheek plate assembly 20. Further, the plastic overmolding allows the double-lock slots 74, 75 and the keyway openings 84, 86 (124, 126) to be beveled on each side of the base frame 26.

The bow 18 is preferably formed from stainless steel powder which is sintered, i.e., first, subjected to pressure in a mold and second, subjected to heat. Just prior to application of high pressure, some of the metal powder is removed so that rounded edges of 0.040-0.120 inch can be formed, preferably about 0.080 inch. In this way, the bow 18 is made with rounded inner edges 132 and 133 best shown in FIG. 20 for presenting minimal trauma to the wrist of a person being restrained. An inner or base end 110 is formed with the hole 109 and an outer end 134 is tapered and has a blunt point 136 as shown in FIG. 24.

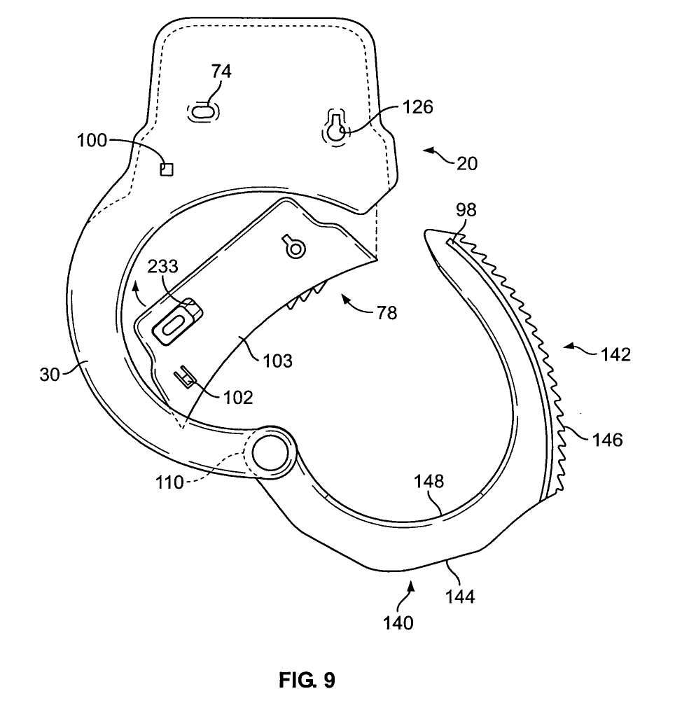

Referring to FIG. 9, the bow 18 includes a first arcuate or curved portion 140 and a second arcuate or curved portion 142 defining a tooth track portion. The first arcuate portion 140 includes the base end 110 with hole 109 therein and has an outer, high contact, flat face 144 which is designed to be applied against the edge of a wrist for pushing the bow 18 through the cheek plate assembly 20 and come full circle about the pivot pin 107 and about a wrist. The second arcuate portion 142 defines a tooth track portion 142 and has spaced, wide, deep set, ratchet teeth 146 formed on an outer side thereof. The tooth track portion 142 is also formed with the arcuate track grooves 96 and 98 on either side thereof.

Further, the bow 18 is polymer infused to inhibit, if not altogether prevent rust or corrosion of the bow 18 and to inhibit, if not to altogether prevent, absorption of body fluids from the wrist of a person being restrained into the bow 18.

Additionally, and according to one of the teachings of the present invention, the envelope formed on an inner edge surface 148 of the bow starting from the base end 110 and extending to the pointed outer end 136 of the bow 18 is formed according to a conic path having an increasing arc so as to form an envelope adapted to receive various sized wrists at different positions of the bow 18 relative to the cheek plates or arms 28, 30 of the cheek plate assembly 20 and with a minimum of pressure applied to the wrist. Stated otherwise the conic path of the surface 148 is a curve generated by a projection of a portion of a conic onto a flat plane. The software for generating the design of this conic path is sold by Parametric Technologies Corporation of Needham, Mass. under their trademark, Pro/ENGINEER 3-D.

The conic path can be defined as follows:

Imagine taking a “string” and curling it around a cone starting from the top of a cone and going to the bottom of the cone. This establishes a conic path. Then the lower portion of that conic path is projected onto a plane and by trial and error, i.e. by adjusting the slope of the “string” and/or the angle at the apex of the cone, a conic path can be created empirically which closest approximates the human wrist for both a large wrist and for a small wrist. In this way, the envelope of the inner surface 148 formed when the bow 18 is engaged about a wrist and of the cheek arms 28, 30 extending about a wrist provide a close approximation to the envelope of the wrist and is slightly larger than the envelope of a prior art handcuff. It will be under stood that the envelope of the cheek arm plates 28 and 30 through the base frame 26 to the corners 92 and 94 of the unitized base frame 26 follows a similar conic path. The largest area created by the bow 18 and cheek plate assembly 20 when a first tooth 106 engages a tooth 209 in the lockset assembly 78 is about 5.67 square inches and the smallest area created when a last tooth 146 engages a tooth 209 in the lockset assembly 78 is about 2.8 square inches.

Again, it will be understood that the envelope of the inner edges of the cheek plate arms 28, 30 going from the outer ends 42 and 44 having the pivot pin mounting holes 38 and 40 to the entry point of the bow 18 between the corners 92 and 94 of the base frame 26, also follows a similar or the same conic path having an increasing arc.

Referring now to FIG. 8, there is illustrated therein the components of the replaceable lockset assembly 78 constructed according to one of the teachings of the present invention.

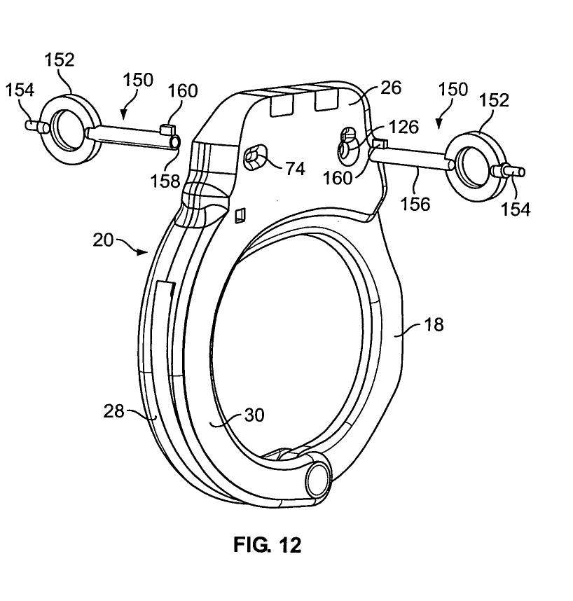

The lockset assembly 78 shown in FIGS. 11 and 16-21 is constructed for use with conventional handcuff key 150 as shown in FIG. 12. Such a key 150 includes a ring-shaped handle 152 having a short actuating end pin 154 extending rearwardly therefrom and a shaft 156 extending forwardly therefrom to an outer, hollow cylindrical end 158. On the other surface of the outer cylindrical end 158 is a single, generally rectangularly shaped, tooth 160. This key 150 is generally standard for use in opening handcuffs and is adapted to be inserted into a keyway in a handcuff and rotated to lock and unlock the handcuff.

The rearwardly extending pin 154 is used to set the position of a double lock bar 77 in a lockset assembly, as will be explained in greater detail hereinafter.

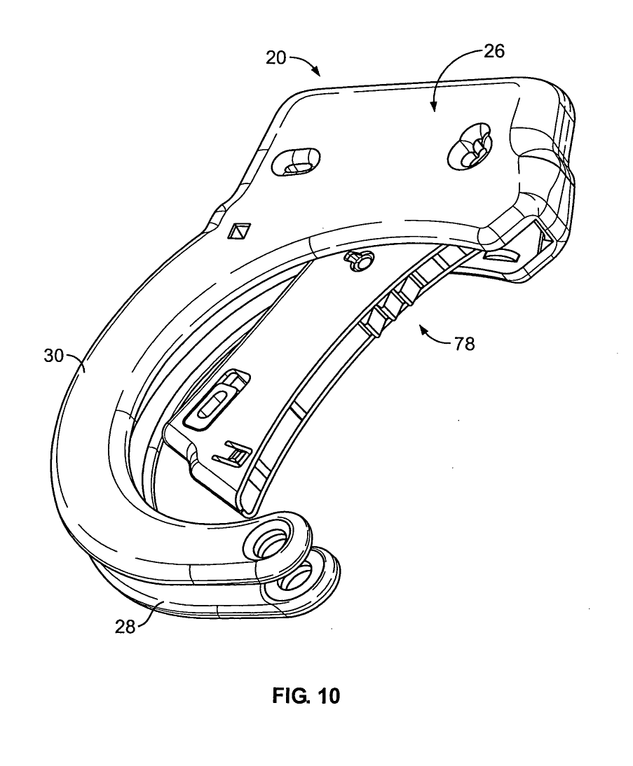

Referring again to FIG. 8, the lockset assembly 78 includes the housing 105 (FIG. 10) that includes the housing shell 104 and the housing cover 103. Inside the housing 105, there is positioned the double lock bar 77, a double lock bar pawl 162, a lock spring 164 and spring tip 166.

The housing shell 104 includes an upper cavity portion 170 and a lower cavity portion 172. The upper cavity portion 170 includes a rounded, generally rectangular shaped section 174 for receiving a generally rectangular-shaped block end 176 of the double lock bar 77. The rectangular-shaped block end 176 has the generally oval lock setting slot 76 extending therethrough for receiving the short actuating pin 154 on the key 150 from either side of the lockset assembly 78. The pin is moved laterally in the slot 76 to move the end 176 and thereby the double lock bar 77 between a single lock position and a double lock position described in greater detail hereinafter.

The double lock bar 77 further includes a bar portion 178 that extends from the generally rectangular shaped end 176 to an opposite end 180-of the double lock bar 77. An upper side surface 182 and a side surface (hidden from view) of the bar portion 178 are smooth for facilitating sliding movement adjacent wall surfaces of the housing shell 104. Preferably the double lock bar 77 is made of a light weight plastic material and colored, e.g., with the color red or white, so that the end 176 with slot 76 or pin actuation area easily can be seen through the double lock slots 74 and 75 in the base frame 26. The color of the lock bar is selected from a high visibility color such as (but not limited to) red, yellow, blue or green, a neon color, a florescent color or a glow-in-the-dark color, that contrasts with the frame color of the handcuff. The color of the lock bar can indicate one of: the type of lock mechanism, the level of security for use of the handcuff or the governmental agency which is using the handcuff.

In prior art handcuffs, the lock bar used was made of metal and had some weight such that one could hit the hand cuff against a hard surface and cause the heavy metal lock bar to move from a double lock position to a single lock position. The provision of the lightweight, plastic lock bar 77 prevents such jarring or moving of the lock bar 77 should the handcuff 12 be hit against a hard surface with the lock bar 77 in a double lock position.

Then, on the lower side of the double lock bar 77 and spaced a short distance from the generally rectangular end 176, there is provided a first space or cavity area 184, then a first step or land 186 followed by a first shoulder 188 going in a direction toward the end 180. Continuing toward the end 180 there is next provided a second space or cavity area 190, a second step or land 192 and a second shoulder 194 adjacent the end 180 of the double lock bar 77.

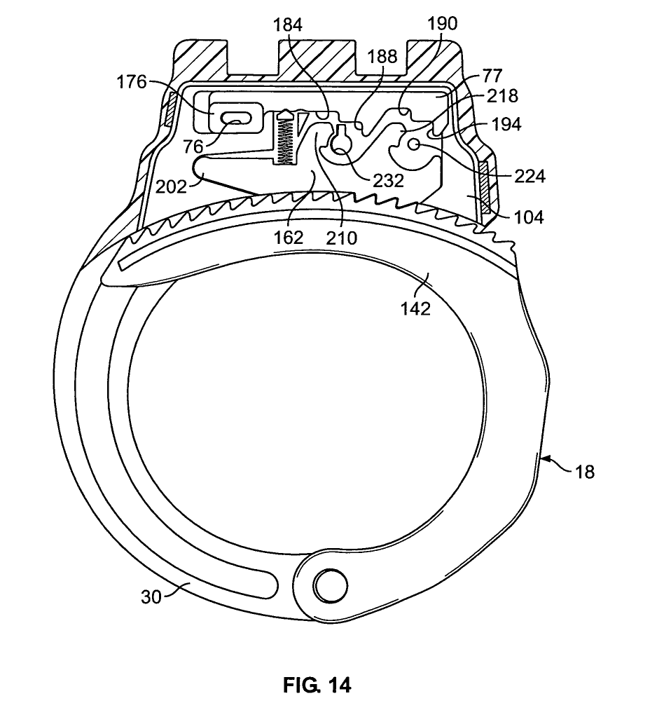

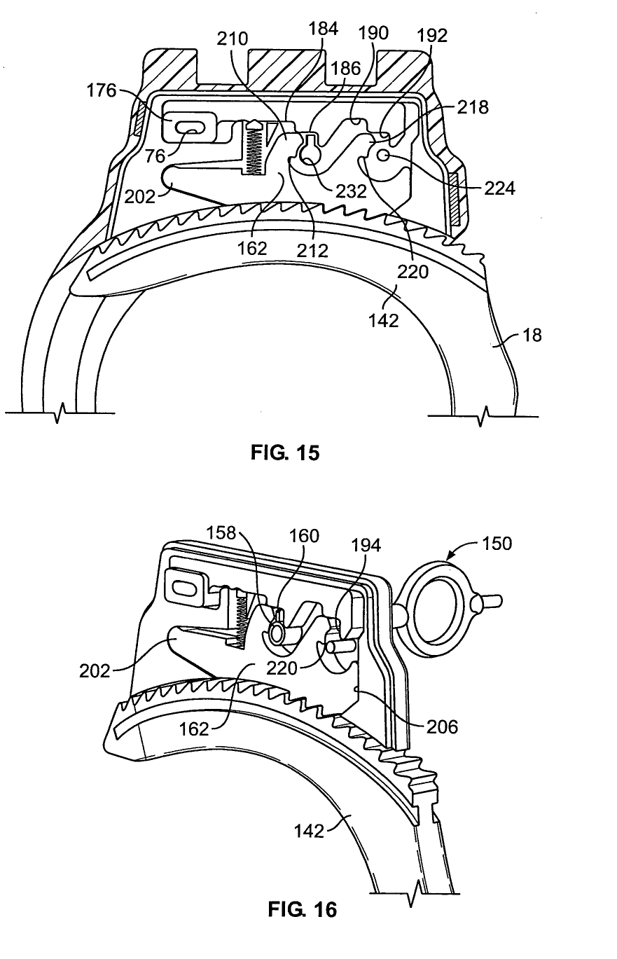

The lock spring tip 166 has an upper wedge shape tip 196 which is movable between two depressions or shallow V-shaped notches 198 and 199, located in the lower side of the double lock bar 77 between the rectangular block end 176 and the first space or cavity area 184, when the double lock bar 77 is moved between a single lock position (FIG. 14) and a double lock position (FIG. 15) to latch releasably the double lock bar 77 in either position. When the double lock bar 77 is moved between the two lock positions by an actuating pin in one direction or by a key in the other direction, the spring 164 is compressed slightly as the wedge shape tip 196 snap-fittingly moves between the depressions or V-shaped notches 198 and 199.

The lower cavity portion 172 of the housing shell 104 has a rounded V-shaped cavity portion 200 into which a rounded end 202 of the double lock bar pawl 162 extends. This end 202 is rounded for pivoting on a rounded end wall 204 of the rounded V-shaped cavity portion 200. An opposite end 206 of the double lock bar pawl 162 is shaped to fit within the lower cavity portion 172 and is arranged for swinging movement within the lower cavity portion 172 about the opposite pivot end 202 of the double lock bar pawl 162.

An outer side 205 of the pawl 162 has a plurality of, typically three, teeth 209 which are constructed, sized and arranged to be received between and mesh with the teeth 146 on the outside of the tooth track portion 142 of the bow 18. On the other or inner side 207 of the double lock bar pawl 162 is a notch 208 for receiving the lock spring 164. The notch 208 is spaced from the rounded end 202. Then, extending from the inner side 207 of the pawl 162 and toward the lock bar 77 is a first leg 210 which, when the double lock bar 77 is positioned to the right as shown in FIG. 18, is positioned opposite the first space or cavity 184 in the double lock bar 77. When the double lock bar 77 is positioned to the left as shown in FIG. 18, the first leg 210 is positioned opposite to and adjacent the first step or land 184 on the double lock bar 77. The first leg has a block end and a curved side that extends to a first ledge 212 that faces back toward the bow 18. Then, a first actuate surface 216 extends from the first ledge 212 in an arcuate path to a second leg 218 which extends away from the inner side 207 of the pawl 162 and toward the double lock bar 77. This second leg 218 also has a block end and a curved side which extends to a second ledge 220. Extending from the second ledge 220 is a second arcuate surface 222 that extends in an arcuate path to the end 206. The first arcuate surface 216 and the second arcuate surface 222 are adapted to interact with the tooth 160 on the key 150 when the key 150 is inserted into the lockset assembly 76 as will be described in greater detail hereinafter.

As shown in FIG. 8, the housing shell 104 has a pin 224 extending from an inner wall surface 226 that extends along a first axis in line with a keyway 228 in the housing cover 103. Then, parallel spaced to this pin 224 is another pin 230 that extends from an inner wall surface of the housing cover 103 toward the housing shell 104 along a second axis which is aligned with a keyway 232 in the wall of the housing shell 104. The keyways 228 and 232 are arranged to be aligned with the keyways 126 and 124 in the overmold on the side plates 48 and 46 of the base frame 26.

It will be understood that the key 150 can be inserted through either keyway 232 or 228 with the hollow circular end 158 of the key 150 then being received over the pin 230 or the pin 224 and with the tooth 160 positioned adjacent the first arcuate surface 216 or second arcuate surface 222 of the double lock bar pawl 162.

A double lock slot 233 is provided in the wall of the housing cover 103 in line with the generally rectangular rounded cavity 174 in the housing shell 104. The housing shell is provided with a similar double lock slot 234. Both double lock slots 233 and 234 are in line with the rectangular end 176 and with the double lock slots 74 and 75 in the side plates 46 and 48 of the base frame 26. The aligned slots 74, 233, 234 and 75 permit the actuating pin 154 on the key 150 to be inserted from either side of the base frame 26 into the lockset assembly 78 for engaging one side of the locksetting slot 76 in the double lock bar 77 for moving the double lock bar 77 from a single lock position to a double lock position as will be described in greater detail hereinafter.

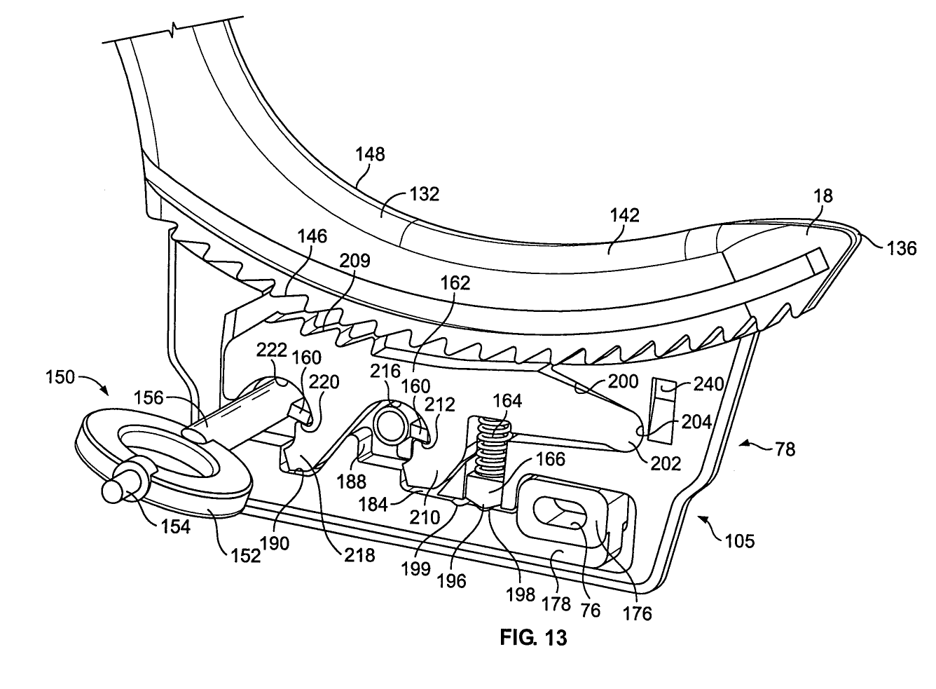

Referring now to FIG. 9, it will be seen that the assembled lockset assembly 78 is pivotally inserted into the hollow interior of the base frame 26 and rotated into and moved linearly into the hollow interior of the base frame 26 until the deflectable detent 102 is snap fittingly received into the latching notch 100 in the side plate 48 of the base frame 26. The progressive movement of the lockset assembly 78 into the base frame 26 is shown in FIGS. 13 and 14.

FIG. 13 is a perspective view of the inside of the lockset assembly 78 with the tooth track portion 142 of the bow 18 adjacent the lockset assembly 78. Here the double lock bar 77 is shown moved to the single lock position. Also, the tooth 160 of either key 150 is shown rotated against the first ledge 212 of the first leg 210 of the pawl 162 or against the second ledge 220 of the second leg 218 of the pawl 162. Note that with the double lock bar 77 in the single lock position, the block ends of the first and second legs 210 and 218 can move into the first and second spaces/cavities 186, 190, respectively by the engagement of the tooth 160 with the ledge 212 or 220 to move the pawl 162 completely out of engagement with the tooth track portion 142 of the tooth track portion of the bow 18. This is the fully unlocked position.

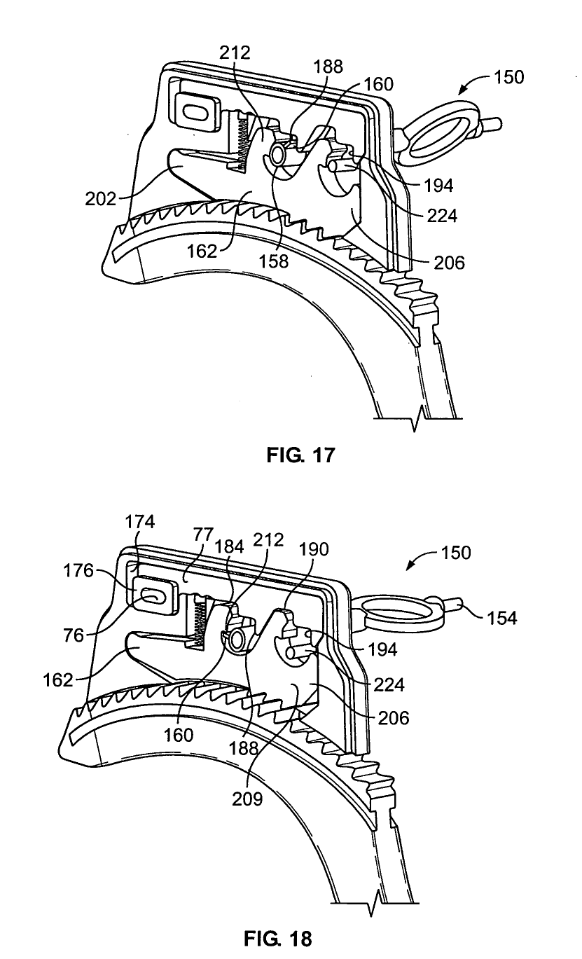

FIG. 17 shows the double lock bar 77 in the single lock position similar to the position shown in FIG. 16, but without a key 150 rotated to a completely unlock position. Here the teeth 146 on the tooth track portion 142 of the bow 18 can ratchet forwardly (to the left) but nor rearwardly (to the right).

In FIG. 15 is shown a double lock position of the double lock bar 77 where the block end of the first leg 210 of the pawl 162 is adjacent the first land or step 186 which prevents movement of the pawl 162 away from the bow 18. This prevents forward movement of the tooth track portion 142 of the bow. Such forward movement of the tooth track portion 142 is also prevented by the juxtaposition of the block end of the second leg 218 adjacent the second land or step 190 on the double lock bar 77.

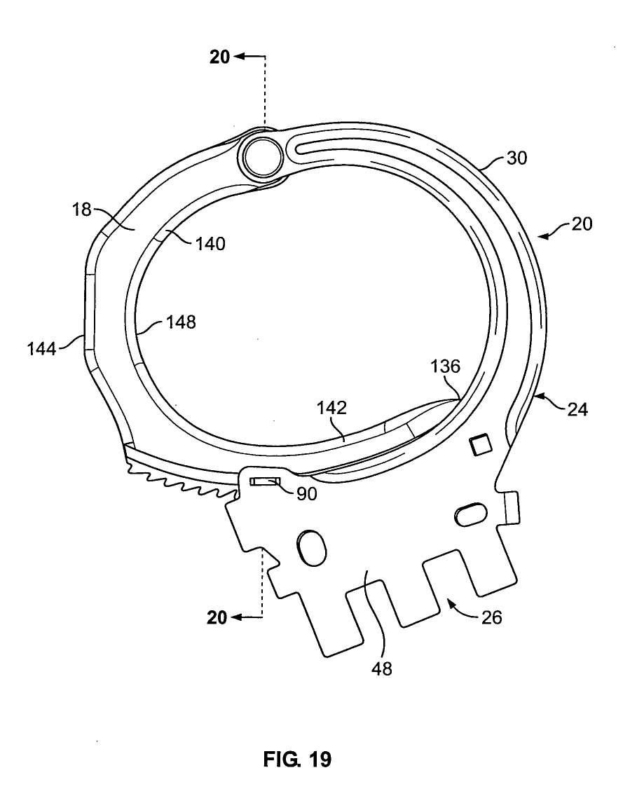

The double lock also can be unlocked with insertion of the key 150 into one of the keyways 232 or 228 in the housing 105. Note that when a key end 158 is inserted into the keyway 232 shown in FIG. 15 or 19, and over the pin 230, the tooth 160 can only be rotated against the first shoulder 188 to move the double lock bar 77 from the double lock position to the single lock position. An attempt to rotate the key 150 in the opposite rotational direction is blocked by the first leg 210 of the pawl 162 which cannot be moved to the left by reason of the rounded end 202 of the pawl 162 bearing against the rounded wall 204. The same result is obtained when a tooth 160 is positioned between the second shoulder 194 of the double lock bar 77 and the second leg 218 of the pawl 162. Thus an end 158 of a key 150 inserted through either keyway 232 or 228 can only be rotated in one rotational direction and this results in the tooth 160 first engaging the shoulder 188 or 194 on the double lock bar 77 to move it to the single lock position. Further rotation of the key end 158 results in a sweep of the tooth 160 adjacent the first or second arcuate surface 216 or 222 on the pawl 162 until the tooth 160 engages the first or second ledge 212 or 220 on the first or second leg 210 or 218 to move the legs 210 and 218 into the spaces 184 and 190 to completely disengage the teeth 209 on the pawl 162 from the teeth 146 on the tooth track portion 142 of the bow 18 as shown in FIGS. 16 and 21.

Whenever the lockset assembly 78 cease to function properly, It will be understood that the lockset assembly 78 can be disengaged from its position within the hollow interior of the base frame 26 by inserting a tool (such as an awl or screwdriver) into the base frame 26 from a position outside of and into and between the cheek arms 28 and 30 and at the same time depress the deflectable detent 102 out of the latching notch 100 and into a recess 240 for this purpose formed in the inner wall surface 226 of the housing shell 104 and pry the lockset assembly 78 out of the base frame 26 to replace the same. This will be done in steps starting with the position of the lockset assembly 78 inside the base frame 26 and then going to the position shown in FIG. 11 and then the position shown in FIG. 10 and then finally to the fully released position shown in FIG. 9.

FIG. 12 illustrates another important feature of the handcuffs 10 of the present invention, namely the ability to insert a key 150 from either side of the handcuff 12 into the base frame 26 for engagement with the double lock bar 77 and pawl 162 inside the lockset assembly 78.

Starting with FIG. 16, which is a perspective view of the locking mechanism inside the lockset assembly 78 shown in FIG. 15, the key 150 is rotated as shown in FIG. 17. This results in the tooth 160 engaging the first shoulder 188 on the double lock bar 77. It will be understood that a key 150 inserted from the other side of the base frame 26 and rotated clockwise will result in the tooth 160 engaging the second shoulder 194 on the double lock bar 77.

Then, as shown in FIG. 18 (and also in FIG. 13), continued rotation of the key 150 will bring the tooth 160 into engagement with the first or second arcuate surfaces 216 or 222 until the tooth 160 engages the first ledge 212 on the first leg 210 or the second ledge 220 on the second leg 218 where the first leg 210 and the second leg 218 are urged toward the spaces 184 and 190 on the double lock bar 77 and at the same time urges the teeth 209 out of engagement with the teeth 146 on the tooth track portion 142 of the bow 18, as best shown in FIGS. 21 and 16.

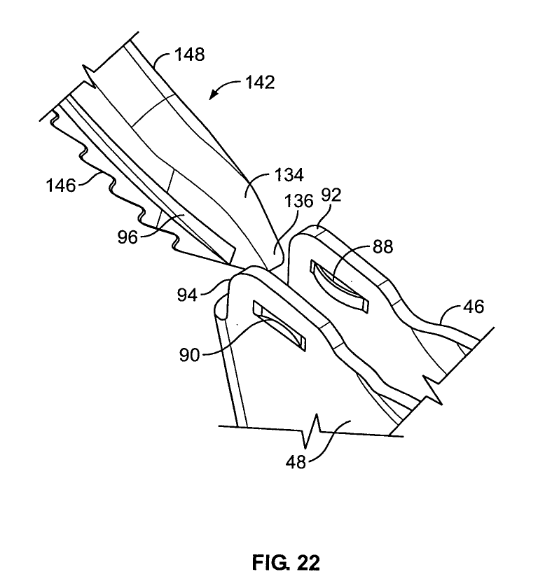

Referring now to FIGS. 22-25, and particularly to FIG. 19, it will be seen that the detents 88 and 90 are located on tangents to a curve of an arc that is generated on a radius between the center of the pivot pin 107 and the center of each detent 88 or 90. As a result, when the bow 18 is rotated counterclockwise in the view of same shown in FIG. 19, the tooth track portion 142 will move smoothly through the cheek plate assembly 20 with the track guides 88, 90 formed by the detents 88, 90 passing through the track groove 96 or 98 on either side of the bow 18.

As best shown in FIGS. 24 and 25, the track guides or detents 88, 90 have a rounded configuration for facilitating engagement with the track grooves 96, 98 and facilitate guiding of the bow 18 between the side plates 46 and 48 of the base frame 26 and thereby through and between the cheek plate arms 28 and 30.

In FIGS. 22-25, the unitized frame assembly is shown prior to encapsulation to better illustrate the relationship between the track grooves 96, 98 in the tooth track portion 142 of the bow 18 and the detents or track guides 88, 90. In FIG. 20 it will be seen that the track guide forming detents 88 and 90 are pushed out of the respective side plates 46 and 48 (into the space between the side plates 46 and 48) and form curved rails that have an outer curved surface which are received in the track grooves 96 and 98. Also the rails have a high lateral strength for holding the bow 18 when a test tension force is applied to the handcuff 12 which tends to pull the cheek plates 28, 30 away from the bow in the base frame 26.

From the foregoing description, it will be understood that the pair of handcuffs 10 of the present invention and the individual handcuffs 12 thereof have a number of advantageous features some of which have been described above and others of which are inherent in the invention. In particular, the set of handcuffs 10 include a bow 18 slightly larger than a prior art bow and arcuate cheek arms slightly larger than prior art cheek arms for engaging wrists of a person to be restrained.

Further, the edges of the actuate cheek arms and of the bow are rounded on the inner surface thereof to minimize trauma to a wrist. The cheek plate assembly is formed from a die stamped metal plate which is folded and bent and includes a frame inner lock as well as reinforcing ribs in the cheek arms which enhance the strength of the cheek plate assembly.

The cheek plate assembly is overmolded with a plastic material to provide rounded edges and beveled edges for keyways and for double lock slots in the cheek plate assembly. The formation of a base frame for the cheek assembly from a die stamp metal plate results in a non-riveted base which is smooth and has a flat profile for placement on a flat surface or on another handcuff.

A flat is provided on the outer surface of the bow for lining up a point of contact of the bow with a wrist and provides smooth movement of the bow relative to the cheek plate assembly when placing the handcuff on a wrist.

The lockset assembly is removable to enable a damaged or non-functioning lockset assembly to be replaced without requiring a complete replacement of the set of handcuffs. The lockset assembly provides a simple lock mechanism with a lock bar having a locksetting slot which can be manipulated by an actuating pin on a conventional handcuff key or by the conventional handcuff key for putting the lock mechanism in a double or single lock position. Then two keyways are provided on either side of the base frame to enable a key to be inserted into the handcuff from either side of the handcuff.

The interacting parts of the lock mechanism, namely, the legs on the lock bar pawl and the spaces or cavities on the slidable double lock bar are constructed and arranged so that a key inserted through either keyway on either side of the base frame can only be rotated in one direction. Further, when the key is inserted, it is first rotated to move the double lock bar from a double lock position into a single lock position and then to move legs or fingers depending from the pawl toward the double lock bar to completely disengage the pawl from the teeth on a teeth track portion of the bow.

A deflectable detent is provided on the housing for the lockset assembly to enable the lockset assembly to be releasably locked in place and then by deflection of the deflectable detent assembly out of a locking notch in the base frame, the lockset assembly can be removed and replaced.

Two hinge sets are provided between handcuffs to provide superior strength. Each hinge set includes three link sets to allow a user to fold the handcuffs 10 over and fit tightly against a user's belt.

Finally, rounded detents are formed in the side plates of the base frame and positioned to engage in track grooves on either side of the track portion of the bow for smoothly guiding the bow through the cheek assembly.

Further, it will be understood that the set of handcuffs of the present invention can be modified without departing from the teachings of the invention. Accordingly, the scope of the invention is only to be limited as necessitated by the accompanying claims.

1. A handcuff assembly that includes a pair of handcuffs comprising:
a frame formed from a continuous sheet of metal with cheek arms on opposing ends of the sheet of metal with a fold in the center so that the cheek arms lie on one end and the fold lies at an opposing end of the folded sheet and a notch in the fold that divides the fold into a plurality of support loops;
the cheek arms formed from the continuous sheet of metal wherein the folded sheet that forms the cheek arms and frame provides a continuous metal plate connection extending from a pivot point of a bow on a distal end of a first cheek arm of the cheek arms down the first cheek arm around the fold and up a second cheek arm of the cheek arms to the pivot point of the bow on a distal end of the second cheek arm;
a flat connector link connecting the pair of handcuffs, the connector link extending into a notch between the plurality of support loops of the frame;
a retaining pin that extends through the plurality of support loops of the frame and through an aperture in an end of the connector link to connect the connector link to the frame; and
an overmold that covers opposing ends of the support loops and that prevents removal of the retainer pin from the frame.

2. The handcuff assembly as in claim 1 further comprising an insert disposed within the notch between the support loops where the insert engages a periphery of the notch and where the insert includes an aperture that correspond in location to an aperture defined by the support loops.

3. The handcuff assembly as in claim 2 wherein the insert further comprises a flange that extends over an outside edge of the support loops and forms a seal with the frame.

4. The handcuff assembly as in claim 3 wherein the flange further comprises a thickness equal to a thickness of the overmold.

5. The handcuff assembly as in claim 4 wherein the overmold is provided by overmolding the base frame and wherein the insert in the slot prevents the overmold from entering a junction between the retaining pin and the connector link.

6. The handcuff assembly as in claim 5 wherein the overmold further comprises a polymer.

7. The handcuff assembly as in claim 1 wherein the flat connector link further comprises a hinge set with a plurality of flat, mutually parallel connector links.

8. The handcuff assembly as in claim 1 wherein the plurality of support loops further comprise three.

9. The handcuff assembly as in claim 8 further comprising two inserts disposed between the three support loops.

10. The handcuff assembly as in claim 9 wherein the flat connector link further comprises two hinge sets where each hinge set is disposed within a respective insert and retained by the retaining pin.

11. A handcuff assembly that includes a pair of handcuffs joined by a connector assembly wherein each handcuff of the pair of handcuffs includes a bow and a cheek plate assembly, the handcuff assembly comprising:
a cheek plate frame assembly within the cheek plate assembly, said cheek plate frame assembly formed from a single, continuous, metal plate with cheek arms on opposing ends with a fold in the center so that the cheek arms lie at a first end of the folded metal plate and the fold lies on a second opposing end of the folded metal plate;
the cheek arms formed from the single continuous metal plate wherein the folded metal plate that forms the cheek arms and cheek plate frame assembly provides a continuous metal plate connection extending from a pivot point of a bow on a distal end of a first cheek arm of the cheek arms down the first cheek arm, around the fold and up a second cheek arm of the cheek arms to the pivot point of the bow on a distal end of the second cheek arm;
a notch disposed in the fold of the folded metal plate that divides the fold into a set of support loops;
a plurality of flat connector links all in a mutually parallel relationship that form the connector assembly wherein an end of at least one flat connector link of the plurality of connector links extends into the notch between a pair of the set of support loops;
a retaining pin that extends through the set of support loops and also through an aperture in an end of the at least one of the flat connector links and that connects the plurality of flat connector links to the cheek plate assembly; and
an overmold that covers opposing ends of the set of support loops and prevents removal of the retainer pin from the cheek plate assembly.

12. The handcuff assembly as in claim 11 wherein the connector assembly further comprises first and second connector assemblies that join the pair of handcuffs.

13. The handcuff assembly as in claim 12 wherein the first and second connector assemblies each comprise three linksets.

14. The handcuff assembly as in claim 11 further comprising an insert disposed within each notch between the support loops where the insert engages a periphery of the notch and where each insert includes a set of apertures that correspond in location to an aperture defined by the support loops.

15. The handcuff assembly as in claim 14 wherein the overmold is provided by overmolding a base frame of the cheek plate frame assembly of each handcuff wherein the insert prevents the overmolded material from entering a junction between the retaining pin and the plurality of flat connector links that are engaged by the retaining pin.

16. The handcuff assembly as in claim 15 wherein the overmold further comprises a polymer.

17. A handcuff assembly that includes a pair of handcuffs joined by a connector assembly where each handcuff of the pair of handcuffs includes a base frame, the connector assembly comprising:
a continuous sheet of metal;
the base frame of each handcuff formed from the continuous sheet of metal with cheek arms on opposing ends of the sheet of metal with a fold in the center so that the cheek arms lie on one end and the fold lies at an opposing end of the folded sheet;
the cheek arms formed from the continuous sheet of metal wherein the folded sheet that forms the cheek arms and frame provides a continuous metal plate connection extending from a pivot point of a bow on a distal end of a first cheek arm of the cheek arms down the first cheek arm around the fold and up a second cheek arm of the cheek arms to the pivot point of the bow on a distal end of the second cheek arm;
a notch within the respective base frames of the pair of handcuffs transverse to a predominant plane of the handcuff, said notch being disposed in the fold of each base frame and that divides the fold into including a plurality of support loops on opposing sides of the notch;
an aperture within the respective base frames disposed along an inner surface of the fold that extends parallel to the predominant axis of the handcuff extending into opposing sides of the notch;
a plurality of interconnected, flat connector links all in a mutually parallel relationship with opposing ends engaging the notches of the base frames;
a retaining pin within the aperture of the respective base frames that engages a flat connector link on opposing ends of the plurality of flat connector links, the plurality of flat connector links being joined to the respective base frames to allow relative rotation in a single plane perpendicular to a predominant plane of one of the handcuff; and
a overmold that blocks opposing ends of the aperture of the respective base frames to prevent disassembly of the connector assembly from the handcuff.

18. The handcuff assembly as in claim 17 further comprising an insert disposed within the notch of the base frame where the insert engages a periphery of the notch and where the insert includes a set of apertures that correspond in location to the aperture within the base frame.

19. The handcuff assembly as in claim 18 wherein the overmold is provided by overmolding the base frame of each handcuff wherein the insert prevents the overmold from entering a junction between the retaining pin and the plurality of flat connector links that are engaged by the retaining pin.

20. The handcuff assembly as in claim 19 wherein the overmold further comprises a polymer.

21. The handcuff assembly as in claim 17 wherein the connector assembly further comprising first and second hinge sets that join the pair of handcuffs.

22. The handcuff assembly as in claim 21 wherein the first and second hinge sets each further comprise three linksets.

23. A handcuff assembly that includes a pair of handcuffs comprising:
a continuous sheet of metal;
a handcuff frame formed from the continuous sheet of metal with cheek arms on opposing ends of the sheet of metal with a fold in the center so that the cheek arms lie on one end and the fold lies at an opposing end of the folded sheet;
the cheek arms formed from the continuous sheet of metal wherein the folded sheet that forms the cheek arms and frame provides a continuous metal plate connection extending from a pivot point of a bow on a distal end of a first cheek arm of the cheek arms down the first cheek arm, around the fold and up a second cheek arm of the cheek arms to the pivot point of the bow on a distal end of the second cheek arm
the bow; and
a lockset within the frame wherein the bow pivots around the pivot point through the cheek arms and engages the lockset within the frame.
